(19) United States
(12) Patent Application Publication
(10) Pub. No.: US 2008/0317528 A1
(43) Pub. Date: Dec. 25, 2008

(54) FUSING DEVICE, IMAGE FORMING APPARATUS HAVING THE FUSING DEVICE, AND FUSING METHOD OF THE IMAGE FORMING APPARATUS

(75) Inventors: Jin-sung Lee, Seoul (KR); Tae-gyu Kim, Hwaseong-si (KR); Su-ho Shin, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/969,967

(22) Filed: Jan. 7, 2008

(30) Foreign Application Priority Data
Jun. 25, 2007 (KR) 2007-62209

(51) Int. Cl. G03G 15/20

(52) U.S. Cl. 399/335

(57) ABSTRACT

A fusing device includes a preheating unit to preheat a developed image on a recording medium, and a heating unit to fuse the preheated developed image onto the recording medium by heating the image without pressing. The preheating unit includes a preheating plate heated by the heating unit and having an airtight interior space, and a phase transition fluid filled in the interior space. The heat generated by the heating unit is stored in the preheating plate using the phase transition fluid, and the temperature of the preheating plate uniform is kept uniform using a non-condensable gas filled in the airtight space of the preheating plate to condense and expand depending on a pressure of the phase transition fluid, and a heat sink arranged corresponding to a charge section of the non-condensable gas to absorb the heat of the preheating plate when the non-condensable gas is contracted.

### CROSS-REFERENCE TO RELATED APPLICATIONS

This application claims the benefit under 35 U.S.C. §119 of Korean Patent Application No. 10-2007-62209, filed on Jun. 25, 2007, in the Korean Intellectual Property Office, the entire disclosure of which is hereby incorporated by reference in its entirety.

### BACKGROUND OF THE INVENTION

1. Field of the Invention

The present general inventive concept relates to an image forming apparatus. More particularly, the present general inventive concept relates to a fusing device having an improved structure to fuse a developed image onto a recording medium, an image forming apparatus having the fusing device, and a fusing method of the image forming apparatus.

2. Description of the Related Art

Generally, an image forming apparatus such as a printer, a copy machine, a scanner, a multifunction device, a facsimile, and the like, is provided with a fusing device that fuses a developed image transferred by a transfer device onto a recording medium. Generally, such a fusing device is classified into a roller type and a belt type.

The roller type fusing device comprises a pair of roller members rotating in close contact with each other, and a heating member built in any one of the roller members. The fusing device fuses a non-fused developed image, which has been transferred to a recording medium, by heating and pressing the developed image when the recording medium passes through a nip portion formed by the pressure contact of the pair of roller members. Since the roller type fusing device has a small temperature drop, it is advantageous in the case where a high-speed printing is performed.

The belt type fusing device comprises a roller member, a belt member rotating in exterior contact with the roller member, a guide member for guiding the rotation of the belt member, and a heating member for heating the nip portion of the belt member. Since this belt type fusing device employs the heating member having a small heat capacity and adopts a partial heating system for heating only the nip portion of the belt member, it can reduce a waiting time for a temperature rise and widen the width of the nip portion in comparison to the roller type fusing device.

However, both the general roller type and belt type fusing devices fuse and press the developed image against the recording medium, and thus they require a structure for pressing the developed image after the image has been heated at a specified fusing temperature by the heating member, thus complicating the structure of the fusing device.

In addition, in the case of pressingly fusing the developed image transferred to the recording medium using a pressing structure composed of a pair of roller members or a roller member and a belt member, the developed image is fused on the recording medium as it is spreading over the recording medium by the pressure, and this causes limitations in heightening the resolution of the printed image. Also, since the recording medium is conveyed with pressure using the roller member or the belt member, the conveying speed of the recording medium becomes low to cause limitations in heightening the printing speed.

### SUMMARY OF THE INVENTION

The present general inventive concept provides a fusing device that can simplify the fusing structure by fusing a transferred image onto a recording medium by heating operations alone, removing the need for a separate pressing structure.

The present general inventive concept also provides a fusing device that can improve the resolution and fusing speed of a developed image transferred to a recording medium by fusing the image onto the recording medium through heating the transferred image without pressing the transferred image to the recording medium.

The present general inventive concept also provides an image forming apparatus incorporating a fusing device of the present general inventive concept, and a fusing method of the image forming apparatus that can achieve a high-resolution and high-speed printing.

Additional aspects and utilities of the present general inventive concept will be set forth in part in the description which follows and, in part, will be obvious from the description, or may be learned by practice of the general inventive concept.

The foregoing and other objects and utilities of the present general inventive concept may be achieved by providing a fusing device including a preheating unit to preheat a developed image transferred to a recording medium, and a heating unit to fuse the preheated developed image onto the recording medium by heating the image.

The preheating unit may include a preheating plate heated by the heating unit and having an airtight interior space, and a phase transition fluid filled in the interior space of the preheating plate.

The phase transition fluid may be water or a heat transfer medium comprising a mixture of diphenyl ether and diphenyl.

The preheating unit may further include a temperature control unit to keep a substantially uniform temperature of the preheating plate.

The temperature control unit may include a non-condensable gas filled in the interior space of the preheating plate to condense and expand depending on a pressure of the phase transition fluid, and a heat sink arranged to correspond to a charge section of the non-condensable gas to absorb heat of the preheating plate when the non-condensable gas is contracted. The non-condensable gas may be nitrogen gas.

The temperature control unit may further include a non-condensable gas storage tank connected to the preheating plate through a pipe.

The preheating unit may further include a conveying unit to convey the recording medium to which the developed image has been transferred.

The conveying unit may include a cover surrounding a top surface and two side part surfaces of the preheating plate, and plural pairs of conveying rollers installed on two interior side part surfaces of the cover to be in rotatable contact with each other, each pair of conveying rollers being disposed at predetermined intervals along a length direction of the cover.

The conveying unit may further include conveying guides inwardly projected from the two interior side part surfaces of the cover to prevent the recording medium from coming undone from the preheating plate.

The preheating unit may further include a supplementary heater to supplement the heating of the preheating plate.

The heating unit may include a heat source, and a reflecting plate to concentrate heat from the heat source toward the developed image.

The foregoing and/or other aspects and utilities of the present general inventive concept may also be achieved by providing a fusing method including heating a preheating plate to which a recording medium having a developed image transferred thereto is to be conveyed, preheating the developed image on the recording medium that is conveyed to the preheating plate with conduction heat from the preheating plate, and fusing the preheated developed image on the recording medium by heating the image with radiation heat from the heating unit.

The fusing method may further include storing the heat generated by the heating unit using a phase transition fluid filled in an airtight space of the preheating plate, keeping the temperature of the preheating plate substantially uniform using a non-condensable gas filled in the airtight space of the preheating plate to condense and expand depending on a pressure of the phase transition fluid, and absorbing the heat of the preheating plate with a heat sink arranged to correspond with a charge section of the non-condensable gas when the non-condensable gas is contracted.

The fusing method may further include conveying the recording medium along the preheating plate using plural pairs of conveying rollers, which are installed on interior surfaces of both side parts of a cover that surrounds three surfaces including both side parts of the preheating plate, to be in rotatable contact with each other at predetermined intervals in a length direction of the cover.

The fusing method may further include keeping a heating temperature of the preheating plate by the heating unit to about 150˜210° C., keeping a preheating temperature of the developed image by the preheating plate to about 80˜130° C., and keeping a fusing temperature of the developed image by radiation heat from the heating unit to about 150° C.

The foregoing and/or other aspects and utilities of the present general inventive concept may also be achieved by providing an image forming apparatus, including a photosensitive medium on which an electrostatic latent image may be formed, a developing device to develop the electrostatic latent image on the photosensitive medium into a developed image, a transfer device to transfer the developed image on the photosensitive medium to a recording medium, and a fusing device to fuse the developed image transferred to the recording medium, wherein the fusing device includes a preheating unit to preheat the developed image transferred to the recording medium, and a heating unit to fuse the preheated developed image onto the recording medium by heating the image.

The preheating unit may include a preheating plate heated by the heating unit and having an airtight interior space, and a phase transition fluid filled in the interior space of the preheating plate.

The preheating unit may further include a temperature control unit to keep a substantially uniform temperature of the preheating plate.

The temperature control unit may include a non-condensable gas filled in the interior space of the preheating plate to condense and expand depending on a pressure of the phase transition fluid, and a heat sink arranged to correspond with a charge section of the non-condensable gas to absorb heat of the preheating plate when the non-condensable gas is contracted.

The preheating unit may further include a conveying unit to convey the recording medium to which the developed image has been transferred.

The conveying unit may include a cover surrounding a top surface and two side part surfaces of the preheating plate, and plural pairs of conveying rollers installed on two interior side part surfaces of the cover to be in rotatable contact with each other, each pair of conveying rollers being disposed at predetermined intervals along a length direction of the cover.

The conveying unit may further include conveying guides inwardly projected from the two interior side part surfaces of the cover to prevent the recording medium from coming undone from the preheating plate.

The preheating unit may further include a supplementary heater to supplement heating of the preheating plate.

The foregoing and/or other aspects and utilities of the present general inventive concept may also be achieved by providing an image fusing device, including a heating unit to preheat a developed image on a recording medium and to reheat the preheated developed image to fuse the developed image onto the recording medium without pressing the developed image.

The foregoing and/or other aspects and utilities of the present general inventive concept may also be achieved by providing an image fusing method, including preheating a developed image on a recording medium with a heating unit, and reheating the developed image with the heating unit to fuse the developed image onto the recording medium without pressing the developed image.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a sectional view schematically illustrating a fusing device according to an embodiment of the present general inventive concept;

FIGS. 2A and 2B are views illustrating preheating plates in different forms, constituting a preheating unit of the fusing device as illustrated in FIG. 1;

FIG. 3 is a view explaining the operation of a preheating plate temperature control unit of the fusing device as illustrated in FIG. 1;

FIG. 4 is a view explaining the structure and operation of a recording medium conveying unit of the fusing device as illustrated in FIG. 1;

FIG. 5 is a side view of FIG. 4;

FIGS. 6A to 6E are views illustrating the operation of the fusing device according to an embodiment of the present general inventive concept;

FIG. 7 is a sectional view schematically illustrating a fusing device according to another embodiment of the present general inventive concept;

FIG. 8 is a sectional view schematically illustrating a fusing device according to another embodiment of the present general inventive concept;

FIG. 9 is a sectional view schematically illustrating a fusing device according to another embodiment of the present general inventive concept; and

FIG. 10 is a sectional view schematically illustrating an image forming apparatus provided with a fusing device according to embodiments of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

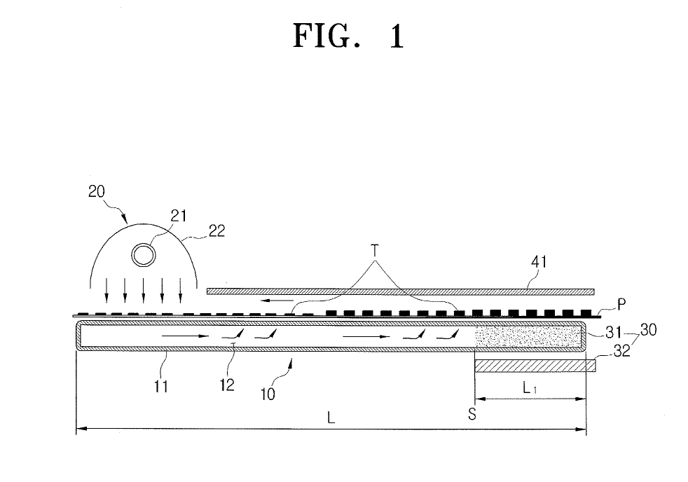

FIG. 1 is a sectional view schematically illustrating a fusing device according to an embodiment of the present general inventive concept.

Referring to FIG. 1, the fusing device according to an embodiment of the present general inventive concept may be provided with a preheating unit 10 to preheat a developed image T transferred to a recording medium P, and a heating unit 20 to fuse the preheated developed image T onto the recording medium P by heating the image. In the fusing device of the present general inventive concept, the developed image T may soak into the recording medium, and may be fused onto the recording medium P by preheating the transferred image, and then reheating the developed image, without having to perform any process of pressing the developed image T transferred to the recording medium P. Accordingly, the structure of the fusing device may be simplified in comparison to a conventional pressure and heating type fusing device. In addition, since it is not necessary to press the developed image T on the recording medium, the resolution of the printed image may be greatly heightened, and the fusing speed may be improved.

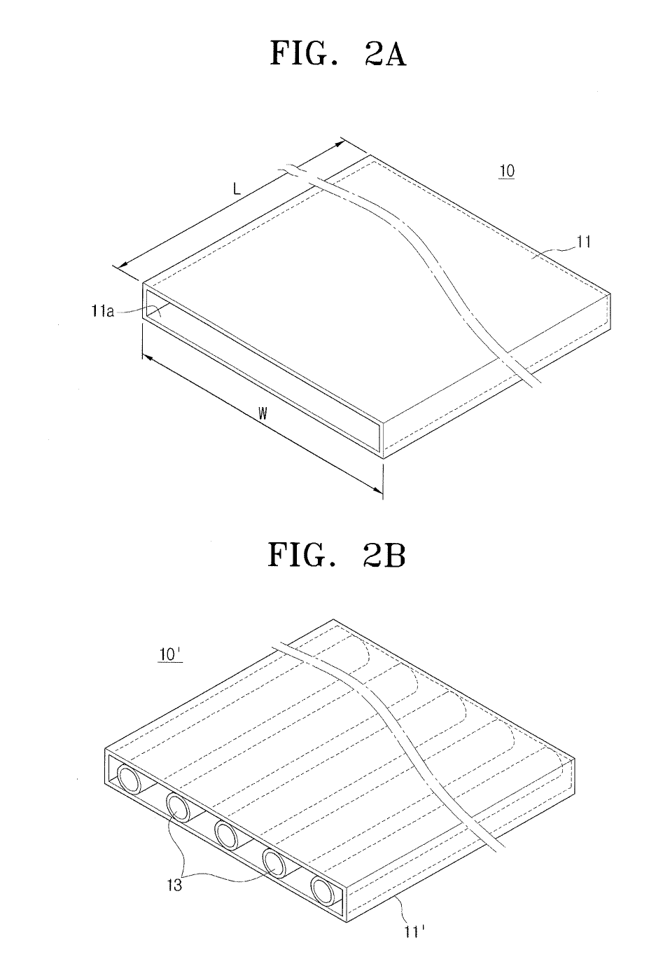

As illustrated in FIGS. 1 and 2A to 2B, the preheating unit 10 may be provided with a preheating plate 11 and having an airtight interior space 11a formed therein. A phase transition fluid 12 may be filled in the interior space 11a of the preheating plate 11, and the preheating plate 11 may be heated by the heating unit 20 so that heat is stored in the preheating plate 11.

As illustrated in FIG. 2A, the preheating plate 11 may be configured in the form of a rectangle having a width W wide enough to accommodate the width of the recording medium P, and a length L that is larger than the width W. The preheating plate 11 may include an airtight interior space 11a formed therein. In an embodiment of the present general inventive concept, the length L of the preheating plate 11 may be set to about 200 mm, but is not limited thereto.

The preheating plate 11 may be made of metal material having a relatively good thermal conductivity, for example copper (Cu), silver (Ag), or aluminum (Al). The interior space 11a may be formed as a single space to maximize the inner area of the interior space 11a.

The interior space 11a may be filled with a phase transition fluid 12, such as water, or a heat transfer medium comprising, for example, of a mixture of diphenyl ether and diphenyl known as trademark “Thermex”. A “phase transition” material is a material whose phase may be changed from solid to liquid or gas through heating of the material. When such a phase transition occurs, the temperature of the material remains substantially unchanged due to potential heat. Potential heat is the amount of energy in the form of heat released or absorbed by a substance during a phase transition.

Accordingly, in the case where water or a heat transfer material is used as the phase transition fluid 12 and the preheating plate 11 is heated with radiation heat of about 800 W for about 10 seconds using the heating unit 20, the temperature of the preheating plate 11 may reach about 200±10° C. In this case, the maximum temperature deviation of the preheating plate 11 has been determined to be merely about 3° C. As such, since the preheating plate maintains a substantially uniform temperature over the whole surface of the preheating plate 11, the developed image T on the recording medium can be preheated at a relatively constant required preheating temperature as it is conveyed along the preheating plate 11. By way of example, the required preheating temperature may be at least more than about 80° C., and the preheating temperature may be in the range of about 80˜130° C.

As illustrated in FIG. 2A, a single interior space 11a may be formed in the preheating plate 11, and the phase transition fluid 12 may be filled into the interior space 11a. However, it is understood that the interior space 11a may be divided into several sub-spaces, and the phase transition fluid may be filled into the respective divided sub-spaces.

Also, as illustrated in FIG. 2B, several heat pipes 13 in which the phase transition fluid may be filled may be built in the preheating plate 11′ to construct the preheating unit 10′.

The heating unit 20 may be provided with a heat source 21, and a reflecting plate 22 to concentrate heat from the heat source 21 toward the developed image T on the recording medium P. A halogen lamp, a heating coil, or a plane heater may be used as the heat source 21. It is an aspect of the present general inventive concept that the power consumption of the heat source 21 should not exceed about 800 W. For example, in the case of a printer for home use, if the power consumption exceeds 800 W, a flicker phenomenon may occur.

In a further aspect of the present general inventive concept, the heating unit 20 may be positioned in the rear of the preheating plate 11 based on the conveying direction of the recording medium P to heat and fuse the developed image T that has been preheated by the preheating unit 10.

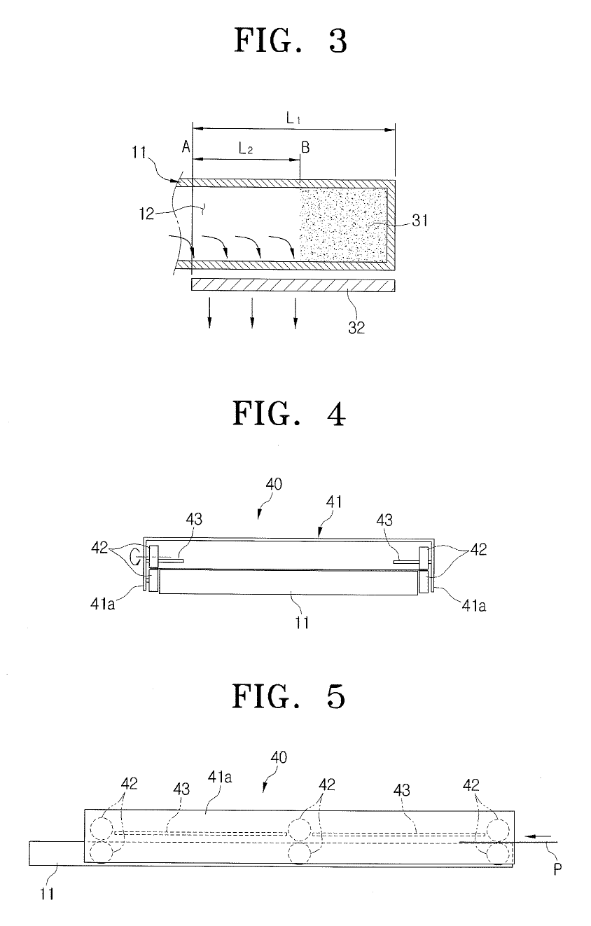

As illustrated in FIGS. 1 and 3, the preheating unit 10 of the fusing device may be provided with a temperature control unit 30 to prevent an abnormal increase of the temperature of the preheating plate 11 due to overheating and to maintain a substantially uniform temperature thereof.

The temperature control unit 30 may include a non-condensable gas 31 filled in the interior space of the preheating plate 11 to condense and expand depending on the pressure of the phase transition fluid 12, and a heat sink 32 arranged to correspond with a charge section L1 of the non-condensable gas 31 may be provided to absorb the heat of the preheating plate 11 when the non-condensable gas is contracted.

For example, the charge section L1 of the non-condensable gas 31 may have a length of about 30 mm if the length of the preheating plate 11 is about 200 mm. When the length of the non-condensable gas 31 is about 30 mm, a boundary surface S may be formed between the non-condensable gas and the phase transition fluid 12 in the interior space of the preheating plate 11. Nitrogen (N2) gas may be used as the non-condensable gas 31.

In a normal pressure state of the phase transition fluid 12, i.e., in a pressure state that the developed image T on the recording medium P may be heated up to about 200° C. (which is a proper temperature to preheat the developed image T), the non-condensable gas 31 is not contracted and the boundary surface S as indicated by position “A” in FIG. 3 may be maintained. As the phase transition fluid is heated, its pressure is increased. However, if overheat is supplied to the preheating plate, the increased pressure of the phase transition fluid 12 may cause the boundary surface S of the non-condensable gas 31 to be contracted as indicated by position “B” in FIG. 3. If the non-condensable gas 31 is contracted, a portion of the charge section of the phase transition fluid 12 may be exposed to the heat sink 32, and thus the phase transition fluid 12 may be cooled as the heat of the phase transition fluid 12 is absorbed in the heat sink 32. If the pressure of the phase transition fluid 12 is returned to the normal state during the cooling of the phase transition fluid, the boundary surface S of the non-condensable gas 31 moves again to position “A” in FIG. 3, and no further cooling occurs. Here, if the amount of heat transfer of the preheating plate 11 is changed to about 200˜500 W, the length L2 of the effective cooling part of the preheating plate 11 according to the change of the amount of heat transfer may be changed to ⅕˜½ of the whole length L1 of the cooling part, so that the preheating plate may be kept at a substantially uniform temperature.

In an embodiment of the present general inventive concept, the fusing device may be provided with a conveying unit 40 to convey the recording medium P to which the developed image T has been transferred along the preheating plate 11.

As illustrated in FIGS. 4 and 5, the conveying unit 40 may include a cover 41 surrounding three surfaces (including the top surface and both side part surfaces of the preheating plate 11), and plural pairs of conveying rollers 42 installed on the two interior side part surfaces 41a of the cover 41. As illustrated in FIG. 5, the conveying rollers 42 may be installed in rotatable contact with each other, and each pair of rollers may be disposed at predetermined intervals along a length direction of the cover 41, so that both edges of the recording medium P having entered into the fusing device may be captured between the conveying rollers 42, and conveyed by the rotation of the conveying rollers 42 through the conveying unit 40. Here, one of the rollers in each pair of conveying rollers 42 may be configured as a driving roller, and the other roller may be configured as a driven roller. In addition, each pair of conveying rollers 42 may be positioned so as not to damage the developed image T on the recording medium P.

In addition, the conveying unit 40 may further include conveying guides 43 inwardly projected from the interior surfaces of the both side parts 41a of the cover 41 to prevent the recording medium P from coming undone from the preheating plate 11 during the conveying of the recording medium by the conveying rollers 42. The conveying guides 43 may be formed along the interior surfaces of the both side parts 41a of the cover 41. Accordingly, the recording medium P can be conveyed in contact with the preheating plate 11 without coming undone from the preheating plate 11.

Since the recording medium P is in contact with the preheating plate 11 as the recording medium P is conveyed by the conveying unit 40, the conduction heat from the preheating plate 11 may be effectively transferred to the developed image T on the recording medium P. However, if the recording medium P becomes wrinkled due to an external cause, the recording medium P may be conveyed through the conveying unit 40 in a state that the recording medium P becomes slightly undone from the preheating plate 11 due to the wrinkle. In this case, the developed image T may not be heated at a proper preheating temperature. Accordingly, in an embodiment of the present general inventive concept in which the length of the preheating plate 11 may be about 200 mm and the temperature of the preheating plate 11 may reach about 200±10° C., it has been determined by experiments that even if an air gap of about 0.5˜1 mm exists between the recording medium P and the preheating plate 11, the developed image T may still be sufficiently preheated at a normal preheating temperature of about 80˜130° C. Accordingly, even if the recording medium is wrinkled, the developed image can be sufficiently preheated.

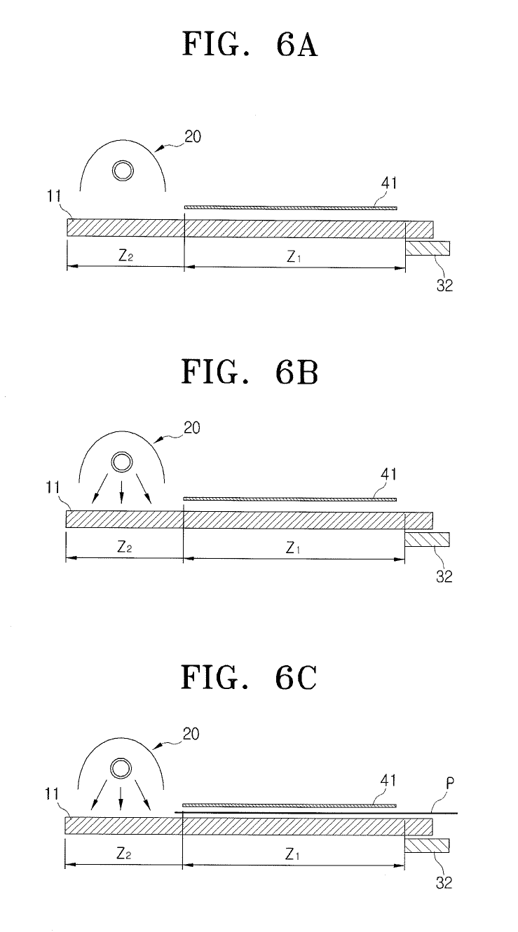

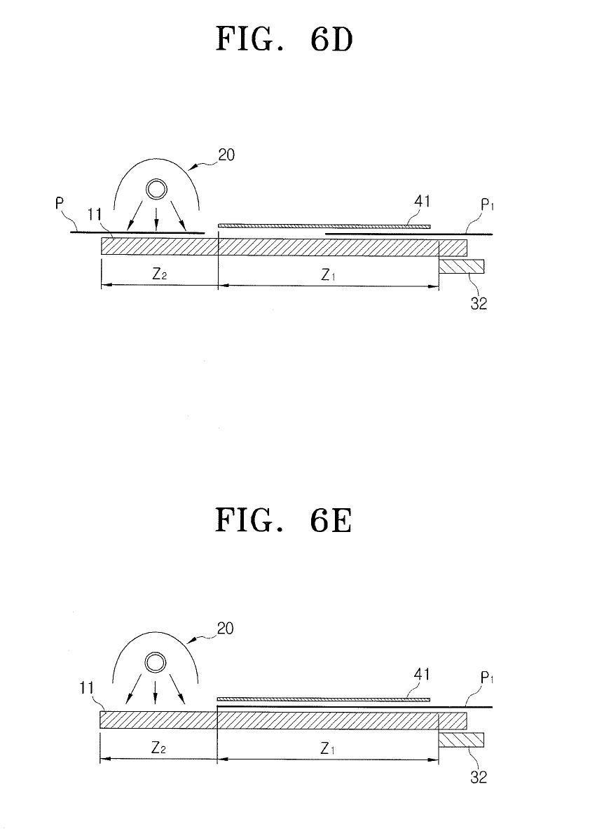

The operation of the fusing device as constructed above in accordance with embodiments of the present general inventive concept will now be described with reference to FIGS. 6A to 6E. Here, Z1 denotes a preheating section, and Z2 denotes a fusing section. The preheating section Z1 refers to a section in which the recording medium P and the developed image T may be preheated by the conduction heat from the preheating plate 11, and the fusing section Z2 refers to a section in which the preheated developed image on the recording medium may be fused onto the recording medium by the radiation heat from the heating unit 20.

FIG. 6A illustrates the state in which the heating unit (e.g., halogen lamp) 20 is turned on according to a printing signal, and FIG. 6B illustrates the state in which the preheating plate 11 is heated by the heating unit 20. The heating of the preheating plate 11 may be performed for about 10 seconds. If the heating is performed for about 10 seconds in a state in which the amount of heat is about 800 W and the heating speed is about 16° C./sec, the preheating plate 11 is heated at about 200° C.

Then, as illustrated in FIG. 6C, as the recording medium P enters into the preheated preheating plate 11 and is conveyed by the conveying unit 40, the recording medium P and the developed image T on the recording medium P may be preheated by the conduction heat from the preheating plate 11. Through this preheating process, the final preheating temperature of the recording medium P that escapes from the preheating section Z1 becomes about 80° C.

The recording medium P exiting from the preheating section Z1, as illustrated in FIG. 6D, passes through the fusing section Z2. In the fusing section Z2, the radiation heat from the heating unit 20 may be applied to the developed image T, thus reheating the developed image T to about 150° C. By reheating the developed image T, the developed image may be fused onto the recording medium P, without a need for a separate pressing operation. As illustrated in FIG. 6D, the preceding recording medium P may be fused and the following recording medium P1 may be entering into the preheating plate 11 to be preheated. FIG. 6E illustrates a state in which the following recording medium P1 enters into the preheating plate 11 and is preheated after the fusing of the recording medium P is completed.

In the above-described fusing process, the heating unit 20 may be always in an “on” state to heat the preheating plate 11 during the printing operation. If an A4-size paper is conveyed, the temperature of the preheating plate 11 may be dropped by about 2.2° C. However, if the radiation heat of the heating unit 20 is received for about 0.14 seconds, the temperature of the preheating plate 11 may be returned to the initial temperature (e.g., about 200° C.), and the temperature of the preheating plate 11 on an average may be maintained at about 200° C. Also, since the interval between the preceding recording medium P and the following recording medium P1 during a continuous printing operation may be about 70 mm, and the radiation heat from the heating unit 20 may be periodically supplied for about 0.7 seconds, problems that occur due to a drop in the temperature of the preheating plate 11 during the continuous printing operation may be avoided.

In addition, if the preheating plate 11 is overheated during the above-described fusing process, the temperature control unit 30 as described above operates to cool the preheating plate 11, and thus the recording medium and the developed image on the recording medium, having entered into the preheating plate 11 at a uniform temperature, can be stably preheated by the preheating plate 11.

The operation of the fusing device according to an embodiment of the present general inventive concept will now be described.

The fusing method according to an embodiment of the present general inventive concept may include heating the preheating plate 11 with a heating unit 20, conveying a recording medium P having a developed image T transferred thereto onto the preheating plate 11, preheating the developed image T as the recording medium is conveyed onto the preheating plate 11 with the conduction heat from the preheating plate 11, and fusing the preheated developed image T on the recording medium P by heating the image T with the radiation heat from the heating unit 20.

In an aspect of the present general inventive concept, the fusing method may store the heat generated by the heating unit 20 using the phase transition fluid 12 filled in the airtight space of the preheating plate 11, and may keep the temperature of the preheating plate 11 substantially uniform using the non-condensable gas 31 filled in the airtight space of the preheating plate 11 to condense and expand depending on the pressure of the phase transition fluid 12, and the heat sink 32 arranged corresponding to the charge section of the non-condensable gas 31 to absorb the heat of the preheating plate 11 when the non-condensable gas 31 is contracted.

Also, the fusing method according to an embodiment of the present general inventive concept may convey the recording medium P along the preheating plate 11 using plural pairs of conveying rollers 42, which may be installed on the interior surfaces of both side parts of the cover 41 that surrounds three surfaces including both side parts of the preheating plate 11, to be in rotatable contact with each other at predetermined intervals in a length direction of the cover 41.

As described above, according to embodiments of the fusing device and methods of the present general inventive concept, one heating unit 20 may be used to perform stable preheating and fusing of the developed image in a non-contact manner by using the heat stored in the preheating plate 11 from the heating unit 20 to preheat the developed image as the recording medium is conveyed onto the preheating plate, and then fusing the developed image onto the recording medium using the radiation heat from the heating unit 20. Accordingly, the construction of the fusing device may be simplified, and the resolution and fusing speed can be improved.

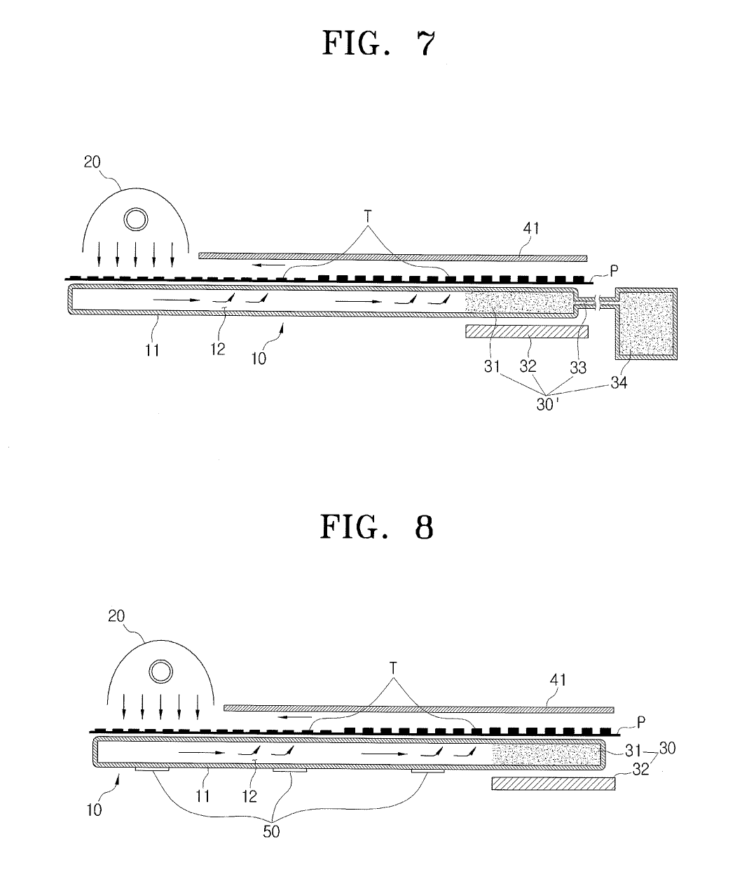

FIG. 7 is a sectional view schematically illustrating a fusing device according to another embodiment of the present general inventive concept. As illustrated in FIG. 7, the fusing device has the same construction as that of the embodiment described above with respect to FIGS. 6A to 6E, except for the construction of a temperature control unit 30′. Accordingly, the same drawing reference numerals are used for the same members and construction having the same functions as those of the embodiment described above, and the detailed description thereof will be omitted.

As illustrated in FIG. 7, the temperature control unit 30′ may include a non-condensable gas 31 filled in the interior space of the preheating plate 11 to condense and expand depending on the pressure of the phase transition fluid 12, a heat sink 32 arranged corresponding to the charge section of the non-condensable gas 31 to absorb the heat of the preheating plate 11 when the non-condensable gas 31 is contracted, and a non-condensable gas storage tank 34 connected to the preheating plate 11 through a pipe 33. In this case, since the non-condensable gas 31 in the preheating plate 11 can be drawn in the storage tank 34, the temperature control range can be further extended. Since the remaining construction and operation of the fusing device according to this embodiment of the present general inventive concept is the same as that of the embodiment described above, the detailed description thereof will be omitted.

FIG. 8 is a sectional view schematically illustrating a fusing device according to another embodiment of the present general inventive concept. As illustrated in FIG. 8, the fusing device according to this embodiment has the same construction as that of the embodiment described above with respect to FIGS. 6A to 6E, except for a supplementary heater 50 installed outside the preheating plate 11 to supplement the heating of the preheating plate 11. Accordingly, the same drawing reference numerals are used for the same members and construction having the same functions as those of the embodiment described above with respect to FIGS. 6A to 6E, and the detailed description thereof will be omitted.

The supplementary heater 50 may be constructed using a heating coil or a plane heater, but is not limited thereto. The supplementary heater 50 can effectively heighten the temperature of the preheating plate 11, and maintain the temperature uniformity of the preheating plate 11.

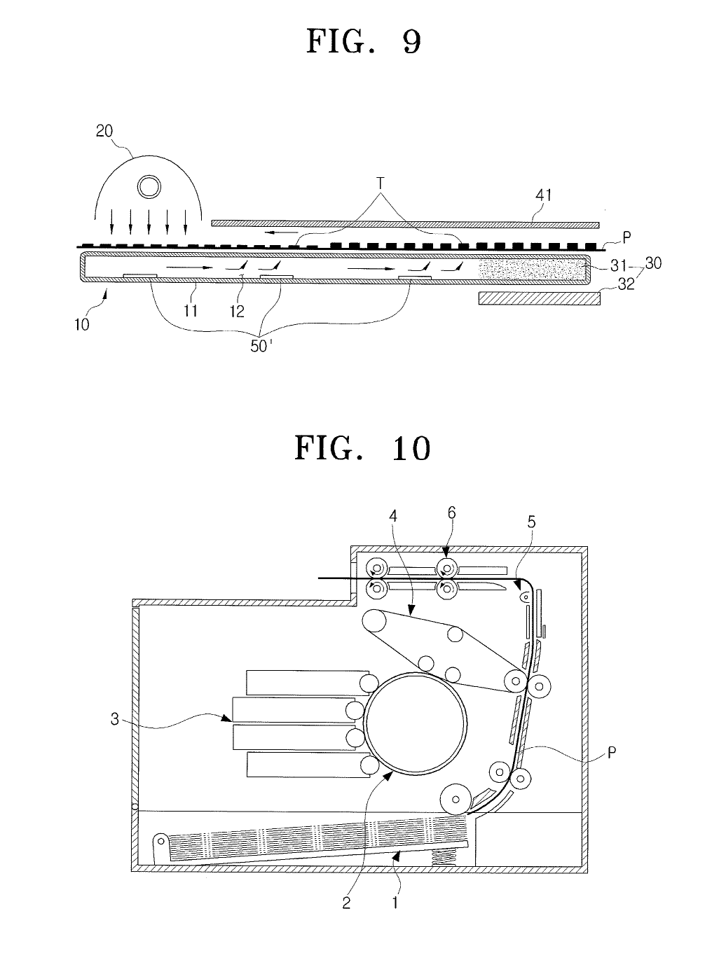

FIG. 9 is a sectional view schematically illustrating a fusing device according to another embodiment of the present general inventive concept. The fusing device according to this embodiment has the same construction as that of the embodiment described above with respect to FIG. 8, except a supplementary heater 50′ may be installed inside the preheating plate 11. Accordingly, a detailed description thereof will be omitted.

FIG. 10 is a sectional view schematically illustrating an image forming apparatus provided with a fusing device according to the present general inventive concept.

As illustrated in FIG. 10, the image forming apparatus may include a feeding device 1, a photosensitive medium 2 on which an electrostatic latent image may be formed, a developing device 3 to develop the electrostatic latent image on the photosensitive medium 2 into a developed image, a transfer device 4 to transfer the developed image on the photosensitive medium 2 to a recording medium P, a fusing device 5 to fuse the developed image transferred to the recording medium P, and a discharging device 6 to discharge the recording medium P.

Since the construction and operation of the feeding device 1, photosensitive medium 2, developing device 3, transfer device 4, and the discharging device 6 are well known in the art, the detailed description thereof will be omitted. The fusing device 5 has the features as described and illustrated above with reference to FIGS. 1 to 6. Accordingly, the image forming apparatus according to the present general inventive concept can meet the recent demand for high speed and high resolution, and satisfy user preferences.

FIG. 10 illustrates an image forming apparatus which incorporates the fusing device according to the embodiment described above with respect to FIGS. 6A to 6E. However, it is understood that the image forming apparatus can also incorporate the fusing devices according to other embodiments of the present general inventive concept as described above.

Further, as described above, since the developed image transferred to the recording medium may be fused on the recording medium in a non-contact manner, a structure to press or pressurize the developed image is not required, and thus the structure of the fusing device can be simplified.

In addition, since the developed image is not rapidly heated, but is gradually heated in the order of preheating and fusing, the occurrence of boiling and scattering of the developed image may be reduced. In addition, the resolution of the printed image may be heightened since the developed image may be fixed to the recording medium without pressure.

In addition, since the fusing device according to the present general inventive concept may adopt the non-contact fusing methods of the present general inventive concept, the fusing speed may be improved, and thus a high-speed and high-resolution image forming apparatus can be achieved.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A fusing device, comprising:
a preheating unit to preheat a developed image transferred to a recording medium; and
a heating unit to fuse the preheated developed image onto the recording medium by heating the image.

2. The fusing device of claim 1, wherein the preheating unit comprises:
a preheating plate heated by the heating unit and having an airtight interior space; and
a phase transition fluid filled in the interior space of the preheating plate.

3. The fusing device of claim 2, wherein the phase transition fluid is water or a heat transfer medium comprising a mixture of diphenyl ether and diphenyl.

4. The fusing device of claim 2, wherein the preheating unit further comprises a temperature control unit to keep a substantially uniform temperature of the preheating plate.

5. The fusing device of claim 4, wherein the temperature control unit comprises:
a non-condensable gas filled in the interior space of the preheating plate to condense and expand depending on a pressure of the phase transition fluid; and
a heat sink arranged to correspond to a charge section of the non-condensable gas to absorb heat of the preheating plate when the non-condensable gas is contracted.

6. The fusing device of claim 5, wherein the non-condensable gas is nitrogen gas.

7. The fusing device of claim 5, wherein the temperature control unit further comprises a non-condensable gas storage tank connected to the preheating plate through a pipe.

8. The fusing device of claim 2, wherein the preheating unit further comprises a conveying unit to convey the recording medium to which the developed image has been transferred.

9. The fusing device of claim 8, wherein the conveying unit comprises:
a cover surrounding a top surface and two side part surfaces of the preheating plate; and
plural pairs of conveying rollers installed on two interior side part surfaces of the cover to be in rotatable contact with each other, each pair of conveying rollers being disposed at predetermined intervals along a length direction of the cover.

10. The fusing device of claim 9, wherein the conveying unit further comprises conveying guides inwardly projected from interior surfaces of the two side part surfaces of the cover to prevent the recording medium from coming undone from the preheating plate.

11. The fusing device of claim 2, wherein the preheating unit further comprises a supplementary heater to supplement heating of the preheating plate.

12. The fusing device of claim 1, wherein the heating unit comprises:
a heat source; and
a reflecting plate to concentrate heat from the heat source toward the developed image.

13. A fusing method, comprising:
heating a preheating plate to which a recording medium having a developed image transferred thereto is to be conveyed;
preheating the developed image on the recording medium that is conveyed to the preheating plate with conduction heat from the preheating plate; and
fusing the preheated developed image on the recording medium by heating the image with radiation heat from the heating unit.

14. The fusing method of claim 13, further comprising:
storing the heat generated by the heating unit using a phase transition fluid filled in an airtight space of the preheating plate;
keeping the temperature of the preheating plate substantially uniform using a non-condensable gas filled in the airtight space of the preheating plate to condense and expand depending on a pressure of the phase transition fluid; and
absorbing the heat of the preheating plate with a heat sink arranged to correspond with a charge section of the non-condensable gas when the non-condensable gas is contracted.

15. The fusing method of claim 13, further comprising:
keeping a heating temperature of the preheating plate by the heating unit to about 150˜210° C.;
keeping a preheating temperature of the developed image by the preheating plate to about 80˜130° C.; and
keeping a fusing temperature of the developed image by radiation heat from the heating unit to about 150° C.

16. An image forming apparatus comprising:
a photosensitive medium on which an electrostatic latent image is formed;
a developing device to develop the electrostatic latent image on the photosensitive medium into a developed image;
a transfer device to transfer the developed image on the photosensitive medium to a recording medium; and
a fusing device to fuse the developed image transferred to the recording medium,
wherein the fusing device comprises:
a preheating unit to preheat the developed image transferred to the recording medium; and
a heating unit to fuse the preheated developed image onto the recording medium by heating the image.

17. The image forming apparatus of claim 16, wherein the preheating unit comprises:
a preheating plate heated by the heating unit and having an airtight interior space; and
a phase transition fluid filled in the interior space of the preheating plate.

18. The image forming apparatus of claim 17, wherein the preheating unit further comprises a temperature control unit to keep a substantially uniform temperature of the preheating plate.

19. The image forming apparatus of claim 18, wherein the temperature control unit comprises:
a non-condensable gas filled in the interior space of the preheating plate to condense and expand depending on a pressure of the phase transition fluid; and
a heat sink arranged to correspond with a charge section of the non-condensable gas to absorb heat of the preheating plate when the non-condensable gas is contracted.

20. The image forming apparatus of claim 17, wherein the preheating unit further comprises a conveying unit to convey the recording medium to which the developed image has been transferred.

21. The image forming apparatus of claim 20, wherein the conveying unit comprises:
a cover surrounding a top surface and two side part surfaces of the preheating plate; and
plural pairs of conveying rollers installed on two interior side part surfaces of the cover to be in rotatable contact with each other, each pair of conveying rollers being disposed at predetermined intervals along a length direction of the cover.

22. The image forming apparatus of claim 21, wherein the conveying unit further comprises conveying guides inwardly projected from the two interior side part surfaces of the cover to prevent the recording medium from coming undone from the preheating plate.

23. The image forming apparatus of claim 17, wherein the preheating unit further comprises a supplementary heater to supplement heating of the preheating plate.

24. An image fusing device, comprising:
a heating unit to preheat a developed image on a recording medium and to reheat the preheated developed image to fuse the developed image onto the recording medium without pressing the developed image.

25. An image fusing method, comprising:
preheating a developed image on a recording medium with a heating unit; and
reheating the developed image with the heating unit to fuse the developed image onto the recording medium without pressing the developed image.
